(19) United States
(12) Patent Application Publication
(10) Pub. No.: US 2010/0070848 A1
(43) Pub. Date: Mar. 18, 2010

(54) PRESERVING THE STRUCTURE OF A LIST IN A DOCUMENT WHILE DISPLAYING AN OUTLINE VIEW OF THE DOCUMENT

(75) Inventor: Scott D. Holdaway, Portland, OR (US)

Correspondence Address: PVF -- APPLE INC.;c/o PARK, VAUGHAN & FLEMING LLP, 2820 FIFTH STREET, DAVIS, CA, 95618-7759, US

(73) Assignee: Apple Inc., Cupertino, CA (US)

(21) Appl. No.: 12/210,922

(22) Filed: Sep. 15, 2008

(51) Int. Cl. G06F 17/21

(52) U.S. Cl. 715/234

(57) ABSTRACT

One embodiment of the present invention provides a system that facilitates preserving the structure of a list in an electronic document while displaying an outline view of the electronic document. During operation, the system receives a command from a user to display an electronic document in an outline view. In response to the command, the system determines a location of a list in the electronic document. Next, the system determines an outline-indentation level for the location in the electronic document. The system then determines an indentation level for each item in the list. Next, the system increases the indentation level for each item in the list by the outline-indentation level. Finally, the system displays the electronic document in the outline view.

### BACKGROUND

1. Field of the Invention

The present invention relates to electronic documents. More specifically, the present invention relates to a method and an apparatus that facilitates preserving the structure of a list in a document while displaying an outline view of the document.

2. Related Art

Word-processing applications typically allow a user to view his or her document using different views, such as: What-You-See-Is-What-You-Get (WYSIWYG) views, standard views, page-layout views, notebook-layout views, and outline views. Each of these views can assist the user in performing different tasks.

One such view, the outline view, provides a user with a quick look at the structure of a document, which enables the user to quickly alter the structure of the document. In a typical outline view, the document is organized as a single outline, wherein the indentation level of items in the outline represents different structural elements of the document. For example, a “root”-level node in the outline with no indentation represents a top-level header, a second-level node may represent a second-level header, and a third-level node may represent a paragraph in the document. Note that the mapping of document items to nodes may differ between documents and is based on the characteristics of different structural types within the document.

Furthermore, outline views typically let users collapse and expand branches of the outline to show or hide portions of the document. Moreover, they also allow users to manipulate the outline to make corresponding structural changes in the document itself. For example, a user can adjust the indentation level for a node in the outline to change the heading level of the corresponding content. A user can also rearrange the order of the branches in the outline to rearrange the entire flow of the document.

Because the structure of an outline view uses indentation levels to represent different structural types within the document, the outline view is not suited for displaying lists and outlines that are contained within the document. For example, when a document includes an embedded list, and the document is displayed in outline view, all of the items in the embedded list are typically shown with the same indentation level because the indentation level implies structural types within the document.

Hence, what is needed is a technique for displaying embedded lists and outlines within an outline view without the problem listed above.

### SUMMARY

One embodiment of the present invention provides a system that facilitates preserving the structure of a list in an electronic document while displaying an outline view of the electronic document. During operation, the system receives a command from a user to display an electronic document in an outline view. In response to the command, the system determines a location of a list in the electronic document. Next, the system determines an outline-indentation level for the location in the electronic document. The system then determines an indentation level for each item in the list. Next, the system increases the indentation level for each item in the list by the outline-indentation level. Finally, the system displays the electronic document in the outline view.

In some embodiments of the present invention, the system determines an outline adornment for the outline-indentation level. Next, the system prepends the outline adornment to the beginning of each item in the list while displaying the electronic document in the outline view.

In some embodiments of the present invention, the system determines an outline adornment for the indentation level of the item. Next, the system prepends the outline adornment to the beginning of a line in the electronic document that comprises the item while displaying the electronic document in the outline view.

In some embodiments of the present invention, the system suppresses the display of list labels while displaying the electronic document in the outline view.

In some embodiments of the present invention, if an item in the list of items will not fit on a single line in the outline view, the system truncates the item so that it fits on a single line, and indicates that the item has been truncated.

In some embodiments of the present invention, if an item in the list of items will not fit on a single line in the outline view, the system wraps a portion of the item that does not fit on a first line to one or more additional lines, wherein an indentation level for the one or more additional lines is greater than an indentation level for the first line.

In some embodiments of the present invention, the outline view is a hierarchical view of the structure of the electronic document, wherein at least one of an indentation level and an outline adornment for an item of content in the outline view indicates a structural format of the item of content.

### BRIEF DESCRIPTION OF THE FIGURES

FIG. 1 illustrates a computing environment in accordance with an embodiment of the present invention.

FIG. 2 illustrates an apparatus in accordance with an embodiment of the present invention.

FIG. 3A illustrates an electronic document in a standard view in accordance with an embodiment of the present invention.

FIG. 3B illustrates an electronic document in a traditional outline view in accordance with an embodiment of the present invention.

FIG. 3C illustrates an electronic document in an enhanced outline view that preserves the structure of a list in accordance with an embodiment of the present invention.

FIG. 3D illustrates an electronic document in an alternate enhanced outline view that preserves the structure of a list in accordance with an embodiment of the present invention.

FIG. 4 presents a flow chart illustrating the process of preserving the structure of a list in an electronic document while displaying the electronic document in an outline view in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

One embodiment of the present invention provides a system that facilitates preserving the structure of a list in an electronic document while displaying an outline view of the electronic document. During operation, the system receives a command from a user to display an electronic document in an outline view. In response to the command, the system determines a location of a list in the electronic document. Next, the system determines an outline-indentation level for the location in the electronic document. The system then determines an indentation level for each item in the list. Next, the system increases the indentation level for each item in the list by the outline-indentation level. Finally, the system displays the electronic document in the outline view.

For example, if in a current document the proper indentation level for body text is three indents, and the list is included within a paragraph in the body text, the top level item in the list will be indented three indents. If a second item in the list has one indent in the standard view, then the second item would have four indents in the outline view. In this manner, the list will be indented the same in both a standard view and an outline view, thereby preserving the visual layout of the list for the user.

In some embodiments of the present invention, the system determines an outline adornment for the outline-indentation level. Next, the system prepends the outline adornment to the beginning of each item in the list while displaying the electronic document in the outline view.

Note that the outline adornment may be specific to lists to differentiate the list items from other structures in the document. For example, all of the items in the list may include the same list-specific outline adornment to indicate that the indentation level of the list items is irrelevant for indicating document structure.

In some embodiments of the present invention, the system determines an outline adornment for the indentation level of the item. Next, the system prepends the outline adornment to the beginning of a line in the electronic document that comprises the item while displaying the electronic document in the outline view.

Note that list-specific outline adornments may indicate the specific level in the list. For example, all root-level nodes in the list may include an outline adornment which is unique to root-level nodes in lists. In addition, all second-level nodes may include an outline adornment which is unique to second-level nodes in lists.

In some embodiments of the present invention, the system suppresses the display of list labels while displaying the electronic document in the outline view.

Note that the display or suppression of adornments may be a user-configurable option.

In some embodiments of the present invention, if an item in the list of items will not fit on a single line in the outline view, the system truncates the item so that it fits on a single line, and also indicates that the item has been truncated.

Note that in some embodiments of the present invention, indicating that the item has been truncated can be accomplished by using a special outline adornment at the beginning of the line and by additional punctuation or adornments at the end of the line.

In some embodiments of the present invention, if an item in the list of items will not fit on a single line in the outline view, the system wraps a portion of the item that does not fit on a first line to one or more additional lines, wherein an indentation level for the one or more additional lines is greater than an indentation level for the first line.

In some embodiments of the present invention, the outline view is a hierarchical view of the structure of the electronic document, wherein at least one of an indentation level and an outline adornment for an item of content in the outline view indicates a structural format of the item of content.

In some embodiments of the present invention, if there are paragraphs that are both part of a heading style and part of a list, the system may optionally choose which indentation level (the indentation level of the heading or the indentation level of the list) to use in the outline view of the of the electronic document. In some cases, it is beneficial to use the indentation level of the heading while in the outline view so that the heading information is conveyed to the user.

### Computing Environment

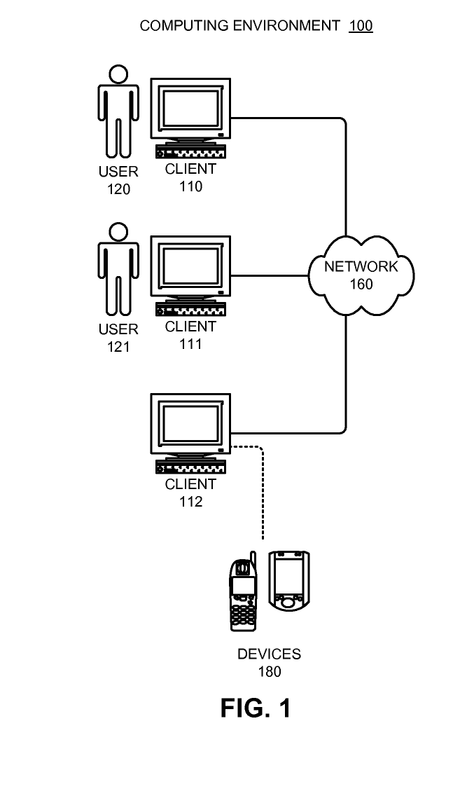

FIG. 1 illustrates a computing environment 100 in accordance with an embodiment of the present invention. Computing environment 100 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 1, computing environment 100 includes clients 110-112, users 120 and 121, network 160, and devices 180.

Clients 110-112 can include any node on a network including computational capability and including a mechanism for communicating across the network. Additionally, clients 110-112 may comprise a tier in an n-tier application architecture, wherein clients 110-112 perform as servers (servicing requests from lower tiers or users), and wherein clients 110-112 perform as clients (forwarding the requests to a higher tier).

Users 120 and 121 can include: an individual; a group of individuals; an organization; a group of organizations; a computing system; a group of computing systems; or any other entity that can interact with computing environment 100.

Network 160 can include any type of wired or wireless communication channel capable of coupling together computing nodes. This includes, but is not limited to, a local area network, a wide area network, or a combination of networks. In one embodiment of the present invention, network 160 includes the Internet. In some embodiments of the present invention, network 160 includes phone and cellular phone networks.

Devices 180 can include any type of electronic device that can be coupled to a client, such as client 112. This includes, but is not limited to, cell phones, personal digital assistants (PDAs), smart-phones, personal music players (such as MP3 players), gaming systems, digital cameras, portable storage media, or any other device that can be coupled to the client. Note that in some embodiments of the present invention, devices 180 can be coupled directly to network 160 and can function in the same manner as clients 110-112.

Note that different embodiments of the present invention may use different system configurations, and are not limited to the system configuration illustrated in computing environment 100.

### Apparatus

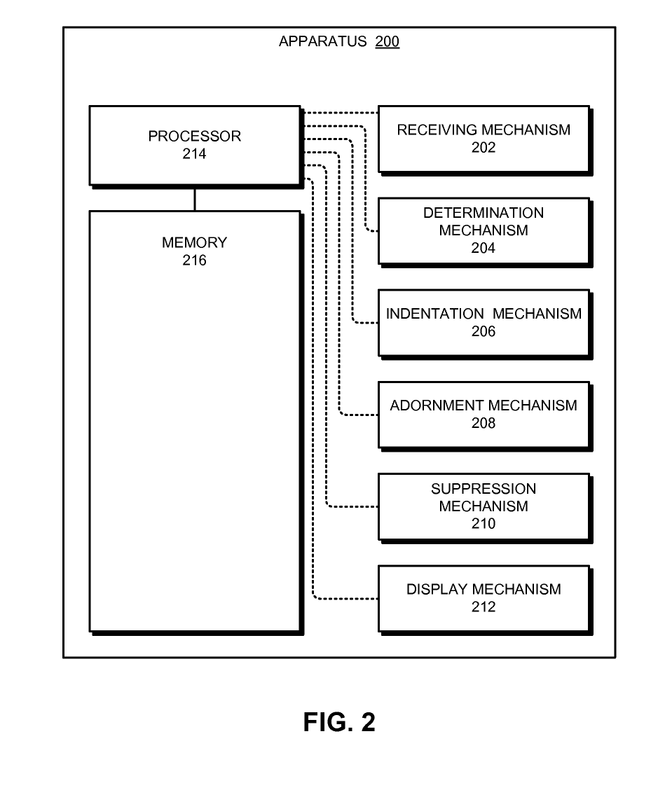

FIG. 2 illustrates an apparatus 200 in accordance with an embodiment of the present invention. Apparatus 200, which can comprise one of clients 110-112 and devices 180, includes receiving mechanism 202, determination mechanism 204, indentation mechanism 206, adornment mechanism 208, suppression mechanism 210, display mechanism 212, processor 214, and memory 216.

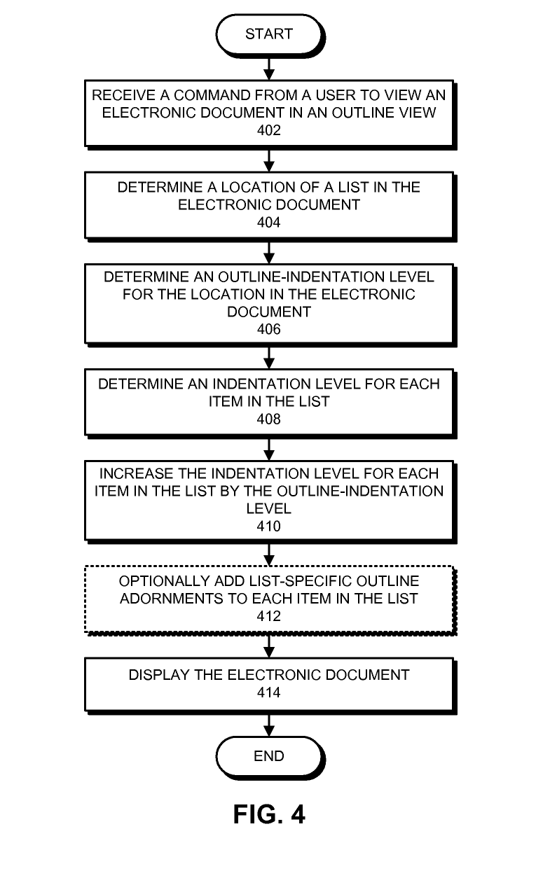

Note that the operation of these mechanisms is described in more detail below in the description of FIG. 4.

### Electronic Document Views

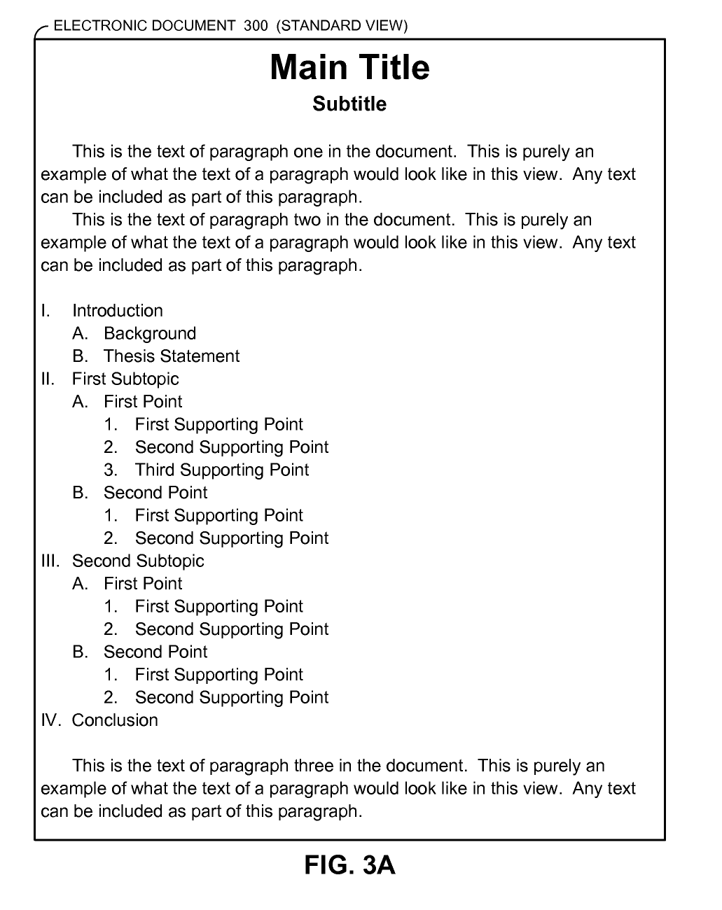

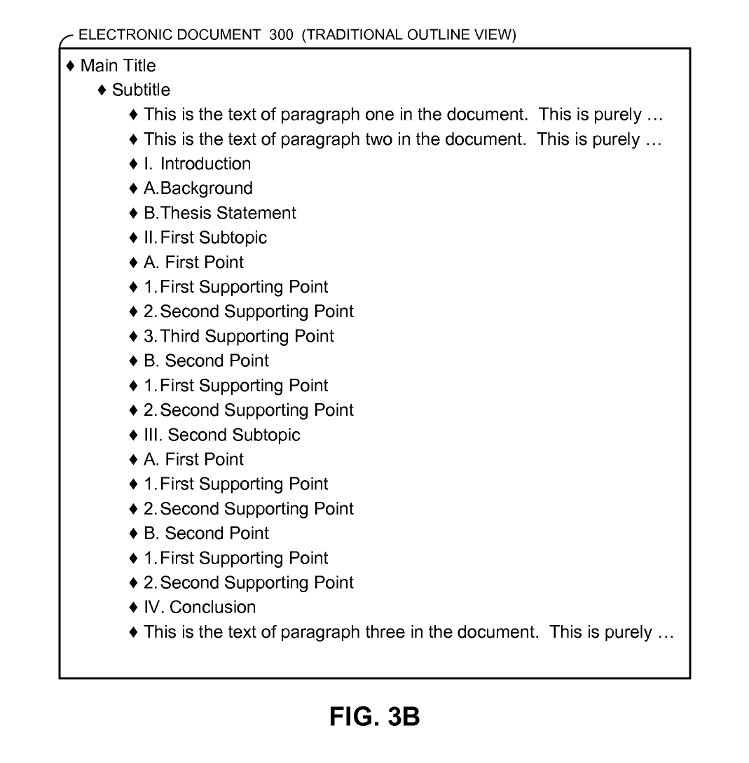

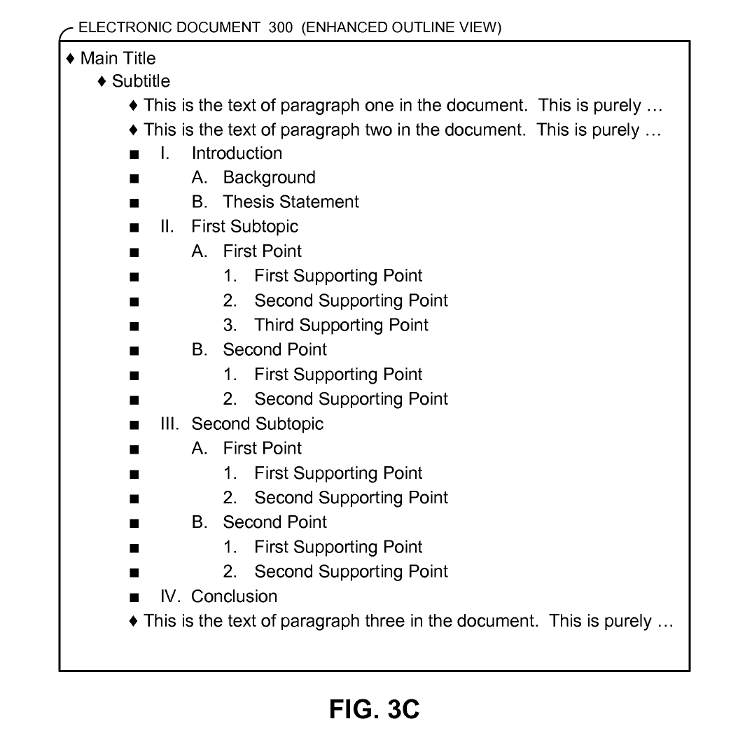

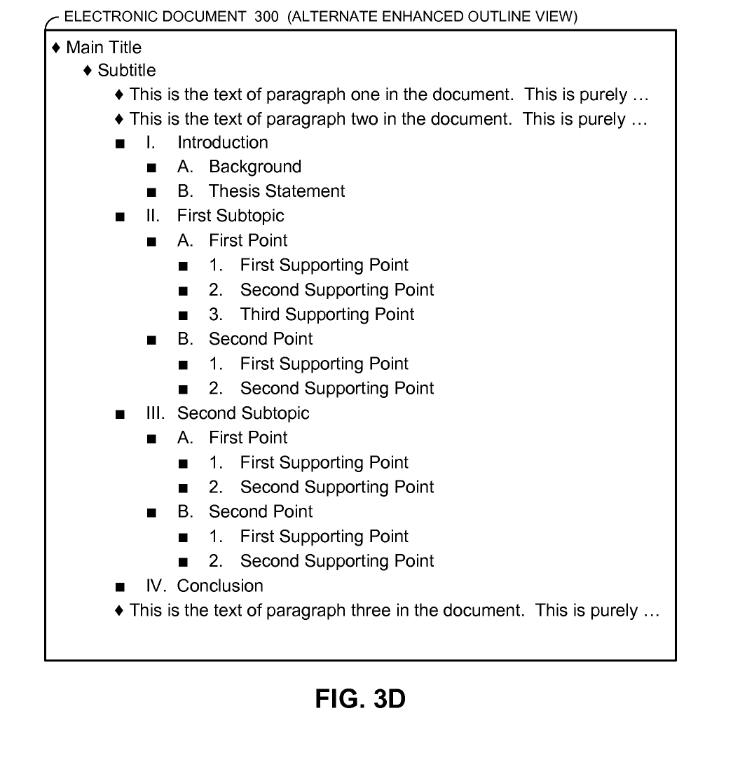

We now present a number of exemplary document views. FIG. 3A illustrates an electronic document 300 in a standard view in accordance with an embodiment of the present invention. FIG. 3B illustrates an electronic document in a traditional outline view in accordance with an embodiment of the present invention. Note that in this view all structural formatting of the list, such as the indentation of each line, is lost.

FIG. 3C illustrates an electronic document in an enhanced outline view that preserves the structure of a list in accordance with an embodiment of the present invention. Note that in this view all structural formatting of the list, such as the indentation of each line, is preserved. Moreover, each item in the list is now prepended with a list-specific outline adornment (black square) that is at the indentation level appropriate for the list as a whole.

FIG. 3D illustrates an electronic document in an alternate enhanced outline view that preserves the structure of a list in accordance with an embodiment of the present invention. Note that in this view all structural formatting of the list, such as the indentation of each line, is preserved. Each item in the list is now prepended with a list-specific outline adornment (black square) that is at the indentation level appropriate for the list item.

### Preserving List Structures While Displaying a Document in an Outline View

FIG. 4 presents a flow chart illustrating the process of preserving the structure of a list in an electronic document 300 while displaying electronic document 300 in an outline view in accordance with an embodiment of the present invention.

During operation, a receiving mechanism 202 receives a command from a user 120 to view an electronic document 300 in an outline view (operation 402). In response to this command, determination mechanism 204 determines a location of a list in electronic document 300 (operation 404). Next, determination mechanism 204 determines an outline-indentation level for the location in electronic document 300 (operation 406). Determination mechanism 204 then determines an indentation level for each item in the list (operation 408).

Next, indentation mechanism 206 increases the indentation level for each item in the list by the outline-indentation level (operation 410). Note that adornment mechanism 208 may optionally add a list-specific outline adornment to each item in the list as described previously (operation 412). Additionally, suppression mechanism 210 may suppress the display of the list labels while electronic document 300 is displayed in the outline view. Finally, display mechanism 212 displays electronic document 300 (operation 414).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for preserving the structure of a list in an electronic document while displaying an outline view of the electronic document, the method comprising:
receiving a command from a user to display an electronic document in an outline view;
determining a location of a list in the electronic document;
determining an outline-indentation level for the location in the electronic document;
determining an indentation level for each item in the list;
increasing the indentation level for each item in the list by the outline-indentation level to display the electronic document in the outline view; and
displaying the electronic document in the outline view.

2. The method of claim 1, further comprising:
determining an outline adornment for the outline-indentation level; and
prepending the outline adornment to the beginning of each item in the list while displaying the electronic document in the outline view.

3. The method of claim 1, further comprising for each item in the list:
determining an outline adornment for the indentation level of the item; and
prepending the outline adornment to the beginning of a line in the electronic document that comprises the item while displaying the electronic document in the outline view.

4. The method of claim 1, further comprising suppressing the display of list labels while displaying the electronic document in the outline view.

5. The method of claim 1, wherein if an item in the list of items will not fit on a single line in the outline view, the method further comprises:
truncating the item so that it fits on a single line; and
indicating that the item has been truncated.

6. The method of claim 1, wherein if an item in the list of items will not fit on a single line in the outline view, the method further comprises wrapping a portion of the item that does not fit on a first line to one or more additional lines, wherein an indentation level for the one or more additional lines is greater than an indentation level for the first line.

7. The method of claim 1, wherein the outline view is a hierarchical view of the structure of the electronic document, wherein at least one of an indentation level and an outline adornment for an item of content in the outline view indicates a structural format of the item of content.

8. A computer-readable storage medium storing instructions that when executed by a computer cause the computer to perform a method for preserving the structure of a list in an electronic document while displaying an outline view of the electronic document, the method comprising:
receiving a command from a user to display an electronic document in an outline view;
determining a location of a list in the electronic document;
determining an outline-indentation level for the location in the electronic document;
determining an indentation level for each item in the list;
increasing the indentation level for each item in the list by the outline-indentation level to display the electronic document in the outline view; and
displaying the electronic document in the outline view.

9. The computer-readable storage medium of claim 8, wherein the method further comprises:
determining an outline adornment for the outline-indentation level; and
prepending the outline adornment to the beginning of each item in the list while displaying the electronic document in the outline view.

10. The computer-readable storage medium of claim 8, wherein for each item in the list the method further comprises:
determining an outline adornment for the indentation level of the item; and
prepending the outline adornment to the beginning of a line in the electronic document that comprises the item while displaying the electronic document in the outline view.

11. The computer-readable storage medium of claim 8, wherein the method further comprises suppressing the display of list labels while displaying the electronic document in the outline view.

12. The computer-readable storage medium of claim 8, wherein if an item in the list of items will not fit on a single line in the outline view, the method further comprises:
truncating the item so that it fits on a single line; and
indicating that the item has been truncated.

13. The computer-readable storage medium of claim 8, wherein if an item in the list of items will not fit on a single line in the outline view, the method further comprises wrapping a portion of the item that does not fit on a first line to one or more additional lines, wherein an indentation level for the one or more additional lines is greater than an indentation level for the first line.

14. The computer-readable storage medium of claim 8, wherein the outline view is a hierarchical view of the structure of the electronic document, wherein at least one of an indentation level and an outline adornment for an item of content in the outline view indicates a structural format of the item of content.

15. An apparatus configured for preserving the structure of a list in an electronic document while displaying an outline view of the electronic document, comprising:
a processor;
a memory;
a receiving mechanism configured to receive a command from a user to display an electronic document in an outline view;
a determination mechanism configured to determine a location of a list in the electronic document;
wherein the determination mechanism is further configured to determine an outline-indentation level for the location in the electronic document;
wherein the determination mechanism is further configured to determine an indentation level for each item in the list;
an indentation mechanism configured to increase the indentation level for each item in the list by the outline-indentation level while displaying the electronic document in the outline view; and
a display mechanism configured to display the electronic document in the outline view.

16. The apparatus of claim 15, further comprising:
an adornment mechanism configured to determine an outline adornment for the outline-indentation level; and
wherein the adornment mechanism is further configured to prepend the outline adornment to the beginning of each item in the list while displaying the electronic document in the outline view.

17. The apparatus of claim 15, further comprising an adornment mechanism, wherein for each item in the list, the adornment mechanism is configured to determine an outline adornment for the indentation level of the item; and
wherein the adornment mechanism is further configured to prepend the outline adornment to the beginning of a line in the electronic document that comprises the item while displaying the electronic document in the outline view.

18. The apparatus of claim 15, further comprising a suppression mechanism configured to suppress the display of list labels while displaying the electronic document in the outline view.

19. The apparatus of claim 15, wherein if an item in the list of items will not fit on a single line in the outline view, the indentation mechanism is further configured to:
truncate the item so that it fits on a single line; and
indicate that the item has been truncated.

20. The apparatus of claim 15, wherein the indentation mechanism is further configured to wrap a portion of an item in the list of items that does not fit on a first line to one or more additional lines if the item will not fit on a single line in the outline view, wherein an indentation level for the one or more additional lines is greater than an indentation level for the first line.
